(19) United States
(12) Patent Application Publication
(10) Pub. No.: US 2024/0209733 A1
(43) Pub. Date: Jun. 27, 2024

(54) METHOD, EQUIPMENT, AND READABLE STORAGE MEDIUM FOR TRACKING AND EVALUATING THE LIFE CYCLE EUR OF HORIZONTAL WELLS

(71) Applicant: Southwest Petroleum University, Chengdu (CN)

(72) Inventors: Yulong ZHAO, Chengdu (CN); Xiangyu LIU, Chengdu (CN); Liehui ZHANG, Chengdu (CN); Xiao HE, Chengdu (CN); Jianfa WU, Chengdu (CN); Zhidong YANG, Chengdu (CN); Jie LI, Chengdu (CN); Bin ZENG, Chengdu (CN); Jian ZHENG, Chengdu (CN); Hongxi LI, Chengdu (CN); Chengzhong BU, Chengdu (CN); Jun PAN, Chengdu (CN); Ruihan ZHANG, Chengdu (CN); Tao ZHANG, Chengdu (CN); Ye TIAN, Chengdu (CN); Huiying TANG, Chengdu (CN); Weihua CHEN, Chengdu (CN); Haoran HU, Chengdu (CN); Cheng CHANG, Chengdu (CN); Deliang ZHANG, Chengdu (CN)

(73) Assignee: Southwest Petroleum University, Chengdu (CN)

(21) Appl. No.: 18/355,372

(22) Filed: Jul. 19, 2023

Related U.S. Application Data
(63) Continuation of application No. PCT/CN2023/096727, filed on May 29, 2023.

(30) Foreign Application Priority Data
Dec. 22, 2022 (CN) 2022116535398

(51) Int. Cl. E21B 49/00; G01V 11/00

(52) U.S. Cl. CPC E21B 49/00; G01V 11/002

(57) ABSTRACT

The present invention discloses a method, equipment, and readable storage medium for tracking and evaluating the life cycle EUR of horizontal wells, and relates to the field of oil and gas development technology. The present invention divides the life cycle stages of fractured horizontal wells in unconventional oil and gas reservoirs, provides corresponding EUR evaluation steps for different life cycle stages based on the production performance characteristics of fractured horizontal wells in unconventional oil and gas reservoirs in the drilling and fracturing stage, extraction and testing stage, rapid production decline stage, and low pressure and small volume production stage, and establishes the EUR tracking and evaluation process of fractured horizontal wells in unconventional oil and gas reservoirs throughout their life cycle from drilling to abandonment.

### CROSS-REFERENCE TO RELATED APPLICATIONS

The application claims priority to Chinese Patent Application No. 2022116535398, filed on Dec. 22, 2022, the entire contents of which are incorporated herein by reference.

### TECHNICAL FIELD

The invention relates to the field of oil and gas development technology, in particular to a method, equipment, and readable storage medium for tracking and evaluating the life cycle EUR of horizontal wells.

### BACKGROUND

EUR represents the cumulative production of oil and gas wells throughout their life cycle, and its accurate evaluation plays an important role in the economic and efficient development of oil and gas resources. By predicting the EUR of oil and gas wells, we can grasp the production trends of oil and gas wells, understand their future production potential, and formulate reasonable oil and gas field development programs.

The horizontal well volume fracturing technology has made it possible to economically and efficiently develop unconventional oil and gas reservoirs, but some new difficulties and challenges have also emerged. The production performance of fractured horizontal wells in unconventional oil and gas reservoirs is complex, which makes it difficult to evaluate their EUR

Researchers have conducted extensive research on EUR evaluation methods. At present, although many EUR evaluation methods for fractured horizontal wells in unconventional oil and gas reservoirs have been developed, these methods are basically one-time applications in the field, and there are lack of EUR tracking and evaluation studies on the life cycle of fractured horizontal wells in unconventional oil and gas reservoirs, and the targeted evaluation according to the actual production characteristics of fractured horizontal wells in unconventional oil and gas reservoirs at different life cycle stages are not carried out. Given the importance of EUR for fractured horizontal wells in unconventional oil and gas reservoirs, it is necessary to conduct studies on the life cycle EUR tracking and evaluation methods to guide the economic and efficient development of unconventional oil and gas resources.

### SUMMARY

In an effort to address at least one of the aforementioned issues, the present invention proposes a method for tracking and evaluating the life cycle EUR of horizontal wells, which can be used to effectively track and evaluate the life cycle EUR values of fractured horizontal wells in unconventional oil and gas reservoirs, and thus to guide the actual production.

The technical solution of the present invention is to provide a life cycle EUR tracking and evaluation method for horizontal wells, comprising the following steps:
S1. Obtain the reservoir physical parameters and engineering construction parameters of the target well, use the remaining wells in the block where the target well is located that have been opened for more than 300 days as reference wells, and obtain the reservoir physical parameters, engineering construction parameters, and EUR values of the reference wells;
S2. Divide the life cycle of the target well:
When the target well is not provided with production data, it is judged to be in the drilling and fracturing stage;
When the opening time of the target well is less than or equal to 15 days, or if the production of the target well continues to increase after the opening, it is judged to be in the extraction and testing stage;
When the production of the target well increases and then decreases, and the time interval between its current production and maximum production is not more than 30 days, it is judged to be in the rapid production decline stage;
When the production of the target well increases and then decreases, and the time interval between its current production and maximum production is greater than 30 days, the Arps decline model is used to fit the production data from the time of maximum production to the current time and calculate the decline rate of production at the current time, and if the decline rate of production at the current time is greater than 0.002d−1, it is judged to be in the rapid production decline stage; If the decline rate of production at the current time is less than 0.002d−1, it is judged to be in the low pressure and small volume production stage;
S3. Conduct EUR evaluation based on the life cycle of the target well;
S4. Repeat S1-S3 at intervals until the target well is abandoned; The interval time shall not be less than 15 days.

Another purpose of the present invention is to disclose a device comprising
A processor, and
An acquisition module, which is used to obtain the reservoir physical parameters and engineering construction parameters of the target well, as well as the reservoir physical parameters, engineering construction parameters, and EUR values of the reference wells,
A storage module, on which a program for the life cycle EUR tracking and evaluation of horizontal wells that can be run on the processor is stored, wherein the program for the life cycle EUR tracking and evaluation of horizontal wells is executed by the processor to implement the steps of the method described above.

Another purpose of the present invention is to disclose a computer-readable storage medium containing executable program code of a processor, wherein the computer-readable storage medium comprises multiple instructions configured to enable the processor to execute the life cycle EUR tracking and evaluation method for horizontal wells described above.

Beneficial effect: In combination with the production performance data, it divides the life cycle stages of fractured horizontal wells in unconventional oil and gas reservoirs, provides corresponding EUR evaluation steps for different life cycle stages based on the production performance characteristics of fractured horizontal wells in unconventional oil and gas reservoirs in the drilling and fracturing stage, extraction and testing stage, rapid production decline stage, and low pressure and small volume production stage, and establishes the EUR tracking and evaluation process of fractured horizontal wells in unconventional oil and gas reservoirs throughout their life cycle from drilling to abandonment.

Meanwhile, the cyclic tracking and evaluation can be used to continuously improve the accuracy of EUR evaluation for the whole oil extraction block, avoiding the impact of blind use of EUR evaluation methods and one-time evaluation of EUR on oil and gas field development programs. The method of the present invention is easy to operate and can be used to enable orderly EUR tracking and evaluation of horizontal wells throughout their life cycle, meanwhile, based on the evaluation results of each stage, it can be used to guide the development of oil and gas wells in that stage, which is conducive to the rational and efficient development of unconventional oil and gas resources.

### BRIEF DESCRIPTION OF DRAWINGS

FIG. 1 illustrates a flowchart of the method in Embodiment 1;

FIG. 2 illustrates a schematic diagram of the division of the target well extraction and testing stage and the rapid production decline stage in Embodiment 1;

FIG. 3 illustrates a schematic diagram of the division of the target well rapid production decline stage and low pressure and small volume production stage in Embodiment 1;

FIG. 4 illustrates the comparison between the predicted EUR by the multi-factor productivity model in the block where the target well is located and actual EUR;

FIG. 5 illustrates the comparison between the predicted EUR by the regression model for testing production in the block where the target well is located and the actual EUR;

FIG. 6 illustrates a fitting diagram of bottom hole flowing pressure of the target well during the rapid production decline stage;

FIG. 7 illustrates a production fitting diagram of the target well during the rapid production decline stage;

FIG. 8 illustrates the fitting results of the Duong decline model when the target well was opened for 1,273 days;

FIG. 9 illustrates the EUR tracking evaluation results of the target well at different production times.

### DETAILED DESCRIPTION OF THE EMBODIMENTS

The specific embodiments of the present invention will be clearly and completely described below with examples and the drawings, and it is clear that the described examples are only a part of the embodiments of the present invention, and not all of them.

### Embodiment 1

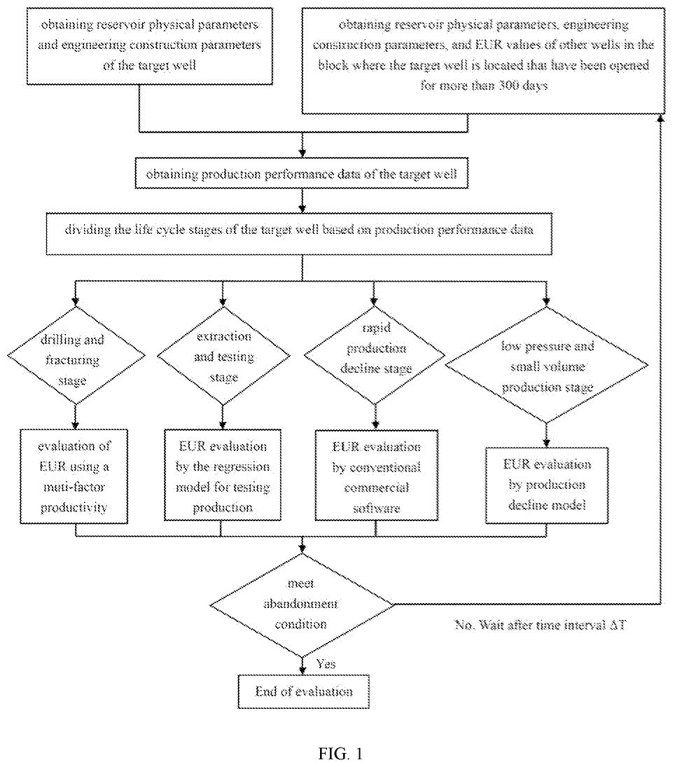

As shown in FIG. 1, the life cycle EUR tracking and evaluation method for horizontal wells includes:
S1. Obtain the reservoir physical parameters and engineering construction parameters of the target well, use the remaining wells in the block where the target well is located that have been opened for more than 300 days as reference wells, and obtain the reservoir physical parameters, engineering construction parameters, and EUR values of the reference wells;
Specifically, the reservoir physical parameters include porosity, permeability, oil saturation, gas saturation, water saturation, and effective reservoir thickness; wherein the following methods can be used to obtain the reservoir physical parameters: relevant experiments can be conducted according to the national standard GB/T 29172-2012 Core Analysis Method by obtaining downhole cores, and the porosity, permeability, oil saturation, gas saturation, and water saturation of the cores can be measured; the effective thickness of the reservoir can be obtained based on the drilling log data.

Engineering construction parameters include wellbore trajectory data, oil casing data, maximum true vertical depth, horizontal section length, fracturing length, number of fracturing sections, average section spacing, total sand addition, total liquid consumption, sand addition intensity, liquid consumption intensity, single stage sand addition, single stage liquid production, peak pump pressure, pump stop pressure, and peak pump displacement.

The reason why the above parameters need to be provided is because the y have a corresponding relationship with the EUR value of a well, and for wells in different blocks, these parameters above have a greater or lesser impact on the EUR value, so a more adequate set of parameters needs to be provided for selection.

S2. Divide the life cycle of the target well:
When the target well is not proved with production data, it is judged to be in the drilling and fracturing stage;
When the opening time of the target well is less than or equal to 15 days, or if the production of the target well continues to increase after the opening, it is judged to be in the extraction and testing stage;
When the production of the target well increases and then decreases, and the time interval between its current production and maximum production is not more than 30 days, it is judged to be in the rapid production decline stage;
When the production of the target well increases and then decreases, and the time interval between its current production and maximum production is greater than 30 days, the Arps decline model is used to fit the production data from the time of maximum production to the current time and calculate the decline rate of production at the current time, and if the decline rate of production at the current time is greater than 0.002d⁻¹, it is judged to be in the rapid production decline stage; If the decline rate of production at the current time is less than 0.002d⁻¹, it is judged to be in the low pressure and small volume production stage. The decline rate of production at the current time referred to here is the ratio of the difference between the production on a given day and its production on the previous day, to the production on the previous day.

At the same time, in this step, the following principles are followed when calculating the production:for oil wells, the production is obtained by converting the gas production of the well into the corresponding oil production and adding it to the actual oil production; for gas wells, the production is obtained by converting the condensate production of the well into the corresponding gas production and adding it to the actual gas production. Oil and gas conversion is a general knowledge in the field, so the specific process will not be elaborated on.

The Arps decline model is used for calculating the production decline rate of production at the current time; if real production data is directly used to calculate the decline rate, the fluctuation of real production will cause drastic changes in the calculated decline rate, making it difficult to reflect the trend of production decline; and the Arps decline model is used to fit the production data from the maximum production to the current time to calculate the decline rate of production at the current time, and the Arps decline model is shown as follows:

$$q = \frac{{{q}_{i}}_{( A r p s )}}{{[ 1 + {nD}_{i} ( t - {t}_{i} ) ]}^{1 / n}}$$

Where, q is the production, in cubic meters; q_{i(Arps)} is the reference production of the Arps decline model, in cubic meters; Dᵢ is the initial decline rate, in d⁻¹; tᵢ is the open well time corresponding to the maximum production, in d; n is the decreasing exponent, dimensionless; t is the open well time, in d.

3. Conduct EUR evaluation based on the life cycle of the target well;
During this process, different methods are used to evaluate the EUR of the target well for different life cycles.

When the life cycle of the target well is in the drilling and fracturing stage, the following steps are used to evaluate its EUR production:

S301. Record reservoir physical parameters and engineering construction parameters as evaluation factors; For the reference well, compose the evaluation factor data into a matrix

$${H}_{\text{?}} = [ \begin{matrix}{h}_{1 , 1} & {h}_{2 , 2} & ⋯ & {h}_{1 , k} \\ {h}_{2 , 1} & {h}_{2 , 2} & ⋯ & {h}_{2 , k} \\ ⋮ & ⋮ & {h}_{i , j} & ⋮ \\ {h}_{i , 1} & {h}_{i , 2} & ⋯ & {h}_{i , k}\end{matrix} ] ,$$

$$\text{?} \text{indicates text missing or illegible when filed}$$

and compose its EUR data into a matrix E_{(t×k)}=[e_{1,1} e_{1,2} . . . e_{1,f} . . . e_{1,k}], where s represents the number of selected evaluation factors and k represents the number of reference wells; Meanwhile, h_{i,j} represents the i-th evaluation factor value of the j-th well, and e_{1,j} represents the EUR value of the j-th well;j=1, 2, . . . , i=1, 2, . . . , s;
S302. Normalize matrix H_{(s×k)} to obtain matrix

$${\overline{H}}_{( s \times k )} = [ \begin{matrix}{\overline{h}}_{1 , 3} & {\overline{h}}_{1 , 2} & … & {\overline{h}}_{1 , k} \\ {\overline{h}}_{2 , 1} & {\overline{h}}_{2 , 2} & … & {\overline{h}}_{2 , k} \\ ⋮ & ⋮ & {\overline{h}}_{i , j} & ⋮ \\ {\overline{h}}_{s , 1} & {\overline{h}}_{s , 2} & … & {\overline{h}}_{s , k}\end{matrix} ] ,$$

and normalize matrix E_{(l×k)} to obtain matrix Ē_{(l×k)}=[ē_{1,1} ē_{1,2} . . . ē_{1,j} . . . ē_{1,j}], where, h̅_{i,j}=h_{1,j}/h_{1,1}, e_{1,j}=e_{1,j}/e_{1,1}; Simultaneously establish matrix

$${G}_{( s \times k )} = [ \begin{matrix}{g}_{1 , 1} & {g}_{1 , 2} & … & {g}_{1 , k} \\ {g}_{2 , 1} & {g}_{2 , 2} & … & {g}_{2 , k} \\ ⋮ & ⋮ & {g}_{i , j} & ⋮ \\ {g}_{s , 1} & {g}_{s , 2} & … & {g}_{s , k}\end{matrix} ] ,$$

where g_{i,f}=h_{1,f}−ē_{1,f};
S303. Establish matrix

$${F}_{( s \times k )} = [ \begin{matrix}{f}_{1 , 1} & {f}_{1 , 2} & … & {f}_{1 , k} \\ {f}_{2 , 1} & {f}_{2 , 2} & … & {f}_{2 , k} \\ ⋮ & ⋮ & {f}_{i , j} & ⋮ \\ {f}_{s , 1} & {f}_{s , 2} & … & {f}_{s , k}\end{matrix} ] ,$$

where

$${f}_{i , j} = \frac{min ( \vert {G}_{( s \times k )} \vert ) + 0.5 \times max ( \vert {G}_{( s \times k )} \vert )}{\vert {g}_{i , j} \vert + 0.5 \times max ( \vert {G}_{( s \times k )} \vert )} ,$$

(min(|G_{(s×k)}|) represent the absolute values corresponding to the element with the smallest absolute value in matrix G_{(x×k)} max (|G_{x×k)}|) represents the absolute value corresponding to the element with the largest absolute value in matrix G_{(s×k)}, and |g_{i,j}| represents the absolute value of element g_{i,j} in matrix G(x×k);
S304. Obtain the correlation matrix U_{(s×t)}=[u_{1,1} u_{2,1} . . . u_{i,1} . . . u_{i,1}]^{T} between each evaluation factor and the EUR value, where

$${u}_{i , 1} = \frac{1}{k} {\sum }_{j = 1}^{k} {f}_{i , j}$$

represents the correlation between the i-th evaluation factor and the EUR value;
S305. Select reservoir physical parameters and engineering construction parameters with a correlation degree greater than 0.7 in S304 as potential influencing factors; Compose the potential influencing factor data of the target well and the reference well into a matrix

$${Q}_{( m \times ( k + 1 ) )} = [ \begin{matrix}{q}_{1 , 1} & {q}_{1 , 2} & … & {q}_{1 , k + 1} \\ {q}_{2 , 1} & {q}_{2 , 2} & … & {q}_{2 , k + 1} \\ ⋮ & ⋮ & {q}_{y , d} & ⋮ \\ {q}_{m , 1} & {q}_{m , 2} & … & {q}_{m , k + 1}\end{matrix} ] ,$$

where m represents the number of potential influencing factors, k represents the number of reference wells, q_{y,d} represents the y-th potential influencing factor value of the d-th well, and d=1, 2, . . . , k, k+1, y=1, 2, . . . , m; The first k columns of matrix Q_{(m×(k+1))} are the potential influencing factor data of the reference well, and the k+1st column is the potential influencing factor data of the target well;
S306. Standardize matrix Q_{(m×(k+1))} to obtain standardized matrix Q′_{(m×(k+1))}, obtain the covariance moment C_{(m×m)} of matrix Q′_{(m×(k+1))}, and then obtain the standard orthogonal feature matrix Z_{(m×m)} of matrix C_{(m×m)}. Then, transpose matrix Z_{(m×m)} to obtain matrix \hat{Z}_{(m×m)}; Multiply matrix by \hat{Z}_{(m×m)} matrix Q′_{(m×(k+1))} to obtain matrix P_{(m×(k+1))};
Calculate the variance FC_{y} of each row in matrix P_{(m×(k+1))}, y=1, 2, . . . , m, and calculate the variance and FCH, where FCH=FC₁+FC₂+ . . . +Fₘ; Arrange the elements of matrix P_{(m×(k+1))} in descending order according to the variance size of each row;
Let GX_{y}=FC_{y}/FCH and GX_{y} be the contribution rates of the y-th row of data in matrix P_{(m×(k+1))} to the original data information. At this time, retain the first w rows of data in matrix P_{(m×(k+1))} with a cumulative contribution rate exceeding 90% to the original data information, and obtain matrix X_{(m×(k+1))};
S307. Build an EUR evaluation multi-factor productivity model for the block where the target well is located, with the specific expression as follows:

$$EUR ( d ) = {\sum }_{i = 1}^{w} {a}_{t} {x}_{i , d} + ε$$

Where, t=1, 2, . . . , w. w is the number of rows in matrix X_{(m×(k+1))}; d=1, 2, . . . , k, k+1. k represents the number of reference wells, EUR(d) is the predicted EUR value of the d-th well, in m³. αₜ and ε are the multi-factor productivity model parameters for the EUR evaluation of the target well in the block, which are constants X_{i,d} is the data in the t-th row and d-th column of matrix X_{(m×(k+1))};
S308. Based on the data in the first k columns of matrix X_{(m×(k+1))} and the EUR value of the reference well, the multi-factor productivity model for EUR evaluation is solved, and the final parameters brought into the target well are the data in the k+1st column of matrix X_{(m×(k+1))}, to obtain the EUR value of the target well.

When the target well is in the extraction and testing stage, the following steps are used to evaluate its EUR value:
S311. Repeat S2 every other day until the end of the extraction and testing stage, and calculate the flowback rate and opening test production of the target well during the extraction and testing stage;
S312. Record reservoir physical parameters and engineering construction parameters as evaluation factors; For the reference well, compose the evaluation factor data into a matrix

$${H}_{( s \times k )} = [ \begin{matrix}{h}_{1 , 1} & {h}_{1 , 2} & … & {h}_{1 , k} \\ {h}_{2 , 1} & {h}_{2 , 2} & … & {h}_{2 , k} \\ ⋮ & ⋮ & {h}_{i , j} & ⋮ \\ {h}_{s , 1} & {h}_{s , 2} & … & {h}_{s , k}\end{matrix} ] ,$$

and compose its EUR data into a matrix E_{(l×k)}=[e_{1,1} e_{1,2} . . . e_{1,j} . . . e_{1,k}] where s represents the number of selected evaluation factors and k represents the number of reference wells; Meanwhile, h_{i,j} represents the i-th evaluation factor value of the j-th well, and e_{1,j} represents the EUR value of the j-th well; j=1, 2, . . . , k, i=1, 2, . . . s;
S313. Normalize matrix H_{(y×k)} to obtain matrix

$${\overline{H}}_{( s \times k )} = [ \begin{matrix}{\overline{h}}_{1 , 1} & {\overline{h}}_{1 , 2} & … & {\overline{h}}_{1 , k} \\ {\overline{h}}_{2 , 1} & {\overline{h}}_{2 , 2} & … & {\overline{h}}_{2 , k} \\ ⋮ & ⋮ & {\overline{h}}_{i , j} & ⋮ \\ {\overline{h}}_{s , 1} & {\overline{h}}_{s , 2} & … & {\overline{h}}_{s , k}\end{matrix} ] ,$$

and normalize matrix E_{(l×k)} to obtain matrix Ē_{(l×k)}=[e_{1,1} e_{1,2} . . . e_{1,l} . . . e_{1,k}], where, h̅_{i,j}=h_{i,j}/h_{i,l}, ē_{1,j}=e_{1,j}/e_{1,l}; Simultaneously establish matrix

$${G}_{( s \times k )} = [ \begin{matrix}{g}_{1 , 1} & {g}_{1 , 2} & … & {g}_{1 , k} \\ {g}_{2 , 1} & {g}_{2 , 2} & … & {g}_{2 , k} \\ ⋮ & ⋮ & {g}_{i , j} & ⋮ \\ {g}_{s , 1} & {g}_{s , 2} & … & {g}_{s , k}\end{matrix} ] ,$$

where g̅_{1,j}=h_{1,j}−e_{1,j};
S314. Establish matrix

$${F}_{( s \times k )} = [ \begin{matrix}{f}_{1 , 1} & {f}_{1 , 2} & … & {f}_{1 , k} \\ {f}_{2 , 1} & {f}_{2 , 2} & … & {f}_{2 , k} \\ ⋮ & ⋮ & {f}_{i , j} & ⋮ \\ {f}_{s , 1} & {f}_{s , 2} & … & {f}_{s , k}\end{matrix} ] , \\ where {f}_{i , j} = \frac{min ( \vert {G}_{( s \times k )} \vert ) + 0.5 \times max ( \vert {G}_{( s \times k )} \vert )}{\vert {g}_{i , j} \vert + 0.5 \times max ( \vert {G}_{( s \times k )} \vert )} ,$$

min(|G_{(s×k)}|) represent the absolute values corresponding to the element with the smallest absolute value in matrix G_{(s×k)}, max(|G_{(s×k)}|) represents the absolute value corresponding to the element with the largest absolute value in matrix G_{(s×k)}, and |g_{1,f}| represents the absolute value of element g_{1,j} in matrix G_{(x×k)};
S315. Obtain the correlation matrix U_{(s×t)}=[u_{1,1} u_{2,1} . . . u_{t,1} . . . u_{s,1}]^{T} between each evaluation factor and the EUR value, where

$${u}_{i , 1} = \frac{1}{k} {\sum }_{j = 1}^{k} {f}_{i , j}$$

represents the correlation between the i-th evaluation factor and the EUR value;
S316. Select reservoir physical parameters and engineering construction parameters with a correlation degree greater than 0.7 in S315 as potential influencing factors; Compose the potential influencing factor data of the target well and the reference well into a matrix

$${Q}_{( m \times ( k + 1 ) )} = [ \begin{matrix}{q}_{1 , 1} & {q}_{1 , 2} & … & {q}_{1 , k + 1} \\ {q}_{2 , 1} & {q}_{2 , 2} & … & {q}_{2 , k + 1} \\ ⋮ & ⋮ & {q}_{y , d} & ⋮ \\ {q}_{m , 1} & {q}_{m , 2} & … & {q}_{m , k + 1}\end{matrix} ] ,$$

where m represents the number of potential influencing factors, k represents the number of reference wells, q_{y,d} represents the y-th potential influencing factor value of the d-th well, and d=1, 2, . . . , k, k+1, y=1, 2, . . . , m; The first k columns of matrix Q_{(m×(k+1))} are the potential influencing factor data of the reference well, and the k+1st column is the potential influencing factor data of the target well;
S317. Standardize matrix Q_{(m×(k+1))} to obtain standardized matrix Q′_{(m×(k+1))}, obtain the covariance moment C_{(m×m)} of matrix Q′_{(m×(k+1))}, and then obtain the standard orthogonal feature matrix Z_{(m×m)} of matrix C_{(m×m)}. Then, transpose matrix Z_{(m×m)} to obtain matrix \hat{Z}_{(m×m)}; Multiply matrix \hat{Z}_{(m×m)} by matrix Q′_{(m×(k+1))} to obtain matrix P_{(m×(k+1))};
Calculate the variance FC_{y} of each row in matrix P_{(m×(k+1))}, y=1, 2, . . . , m, and calculate the variance and FCH, where, FCH=FC₁+FC₂+ . . . +FCₘ; Arrange the elements of matrix P_{(m×(k+1))} in descending order according to the variance size of each row; GX_{y}=FC_{y}/FCH, GX_{y} is the contribution rate of the y-th row of data in matrix P_{(m×(k+1))} to the original data information. At this time, retain the first w rows of data in matrix P_{(m×(k+1))} that have a cumulative contribution rate of more than 90% to the original data information, and obtain matrix X_{(m×(k+1))};
S318. Build a regression model for EUR evaluation of testing production in the block where the target well is located, with the specific expression as follows:

$$EUR ( d ) = {\sum }_{i = 1}^{w} {b}_{t} {x}_{t , d} + α {Q}_{test} ( d ) + β {R}_{hack} ( d ) + φ$$

Where, t=1, 2, . . . , w. w is the number of rows in matrix X_{(m×(k+1))}; d=1, 2, . . . , k, k+1, k represents the number of reference wells, EUR(d) is the predicted EUR value of the d-th well, in m³. b₁, α, β and φ are the multi-factor productivity model parameters for the EUR evaluation of the target well in the block, which are constants x_{l,d} is the data in the t-th row and d-th column of matrix X_{(m×(k+1))}, Qₜₑₛₜ(d) represents the production of the d-th well during the well opening test, in m³, R_{back}(d) represents the flowback rate during the extraction and testing stage of the d-th well;
S319. Based on the data in the first k columns of matrix X_{(m×(k+1))}, as well as the EUR value of the reference well, the production data during the well opening test, and the flowback rate data during the extraction and testing stage, the EUR evaluation regression model for testing production is solved. The parameters of the target well, namely the data in the k+1st column of matrix X_{(m×(k+1))} as well as the production data during the well opening test and the flowback rate data during the extraction and testing stage, can be used to obtain the EUR value of the target well.

When the target well is in the rapid production decline stage, its EUR is evaluated using the conventional commercial software including Harmony, and when the Harmony software is used, the steps are shown below:
S321. Import reservoir physical parameters, engineering construction parameters and production performance data of the target well into the commercial software Harmony;
S322. The five linear flow complex fracture unstable seepage model solver module in commercial software Harmony is used to fit the production history of the target well, and in view of the fact that some parameters are affected by human factors or the accuracy of measuring equipment during the collection of reservoir physical parameters and engineering construction parameters, the reservoir physical parameters and engineering construction parameters of the target well can be further adjusted and determined through the production history fitting process;
S323. Based on the reservoir physical parameters and engineering construction parameters of the target well obtained after the completion of production history fitting in step S322, the productivity prediction module in commercial software Harmony is used to simulate the production performance process of the target well by setting the method of first fixing the production and then fixing the pressure, and finally obtaining the EUR of the target well.

When the target well is in a low pressure and small volume production stage, the following steps are used to evaluate its EUR value:
S331. Use the pauta criterion to judge the data after maximum production and identify abnormal data points; And use the Exponential Moving Average to fill in the marked abnormal data points;
S332. Divide the production data of the filled low pressure and small volume production stage into two sections, record the first half of the data and the production data from the maximum production to the low pressure and small volume production stage as the fitting dataset, and record the production data of the low pressure and small volume production stage as the validation dataset; wherein the first half of the data and the second half of the data can be equally divided or unevenly divided, and when it is unevenly divided, the first half of the data is more than the second half of the data, for example, the ratio of the two can be 7:3 or 8:2;
S333. Use Duong decline model, SEDM decline model, PLE decline model, Arps decline model, Li decline model, and M-L decline model to fit the fitted dataset, and select the optimal decline model based on the error between the calculated production and actual production in the validation dataset, wherein these models are prior art, so the y will not be elaborated on. In the actual production process, the optimal decline models selected for different wells are different, for example, in some cases, the optimal model may be the Duong decline model, while in other cases, the optimal model may be the Li decline model, therefore, in this implementation, different decline models are selected according to the actual situation, which is more in line with the actual situation, and the problem that it is difficult to be widely used when only a single decline model is used in conventional situations is avoided.
S334. Based on the optimal decline model selected in S333, the data of the target well is brought in, and the final EUR value of the target well is calculated.
S4. Repeat S1-S3 at intervals until the target well is abandoned; The interval time shall not be less than 15 days, to maintain tracking and evaluation of the target well throughout its life cycle.

In this embodiment, the EUR value of the reference well, which can also be calculated using the method of this embodiment, is obtained, and the more the EUR value of the reference well is calculated and the more accurate the result is, then the more accurate the evaluation of the EUR value of the target well is. When the target well is opened for more than 300 days, the target well is used as a reference well for the remaining wells in the block in which it is located for EUR evaluation. In this embodiment, the EUR value of the target well can in turn serve as the evaluation basis for the EUR value of the remaining wells, so the method of this embodiment enables an evolving evaluation process in which the overall evaluation results of the block where the target well is located become increasingly accurate.

To further illustrate the method of this embodiment, specific examples will be used below.

The target well in this example is from a shale gas reservoir in Sichuan Basin, and a total of 38 reference wells were obtained for their reservoir physical parameters, engineering construction parameters, EUR values, well opening test production and flowback rates in the

TABLE 1
Parametric statistics of reference wells

| | Minimum | Maximum | Average | | Minimum | Maximum | Average |
|---|---|---|---|---|---|---|---|
| Parameters | value | value | value | Parameters | value | value | value |
| EUR (100 | 1.08 | 1.97 | 1.41 | Pump stop | 36.1 | 69.9 | 51.5 |
| million m³) | | | | pressure | | | |
| | | | | (MPa) | | | |
| Maximum | 2335.8 | 3478.6 | 2792.7 | Total liquid | 20786 | 85323 | 45560 |
| true vertical | | | | consumption | | | |
| depth (m) | | | | (m³) | | | |
| Horizontal | 850.0 | 2556.0 | 1466.7 | Liquid usage | 25.5 | 44.6 | 32.8 |
| section | | | | intensity | | | |
| length (m) | | | | (m³/m) | | | |
| Organic | 3.2 | 5.7 | 4.3 | Single stage | 1553.9 | 1949.9 | 1785.1 |
| matter | | | | liquid | | | |
| content (%) | | | | production | | | |
| | | | | (m³) | | | |
| Gas content | 3.7 | 6.4 | 5.0 | Usage of 100 | 477.4 | 3106.5 | US8.1 |
| (m/t) | | | | mesh | | | |
| | | | | proppant (t) | | | |
| Porosity (%) | 4.4 | 6.4 | 5.4 | Usage of | 751.1 | 4001.3 | 1738.3 |
| | | | | 40 + 70 mesh | | | |
| | | | | proppant (t) | | | |
| Fragile | 53.0 | 78.5 | 67.2 | Total amount | 1522.9 | 5854.0 | 2926.3 |
| mineral | | | | of sand | | | |
| content (%) | | | | added (m³) | | | |
| Number of | 11.0 | 46.0 | 25.7 | Sanding | 1.2 | 2.8 | 2.1 |
| fracturing | | | | strength | | | |
| sections | | | | (m³/m) | | | |
| (section) | | | | | | | |
| Average | 40.0 | 70.9 | 55.5 | Single stage | 65.2 | 172.2 | 116.9 |
| segment | | | | sand addition | | | |
| spacing | | | | (m³) | | | |
| Fracturing | 653.0 | 2314.0 | 1405.8 | Production | 7.S | 40.2 | 23.0 |
| length (m) | | | | capacity of | | | |
| | | | | well opening | | | |
| | | | | test (10000 | | | |
| | | | | m³/d) | | | |
| Peak pump | 12.6 | 16 | 14.7 | Flowback | 7.48 | 79.02 | 37.23 |
| displacement | | | | rate during | | | |
| (m³/min) | | | | extraction | | | |
| | | | | and testing | | | |
| | | | | stage (%) | | | |
| Peak pump | 57.6 | 90.2 | 77.8 | Parameters | | | |
| pressure | | | | | | | |
| (MPa) | | | | | | | |

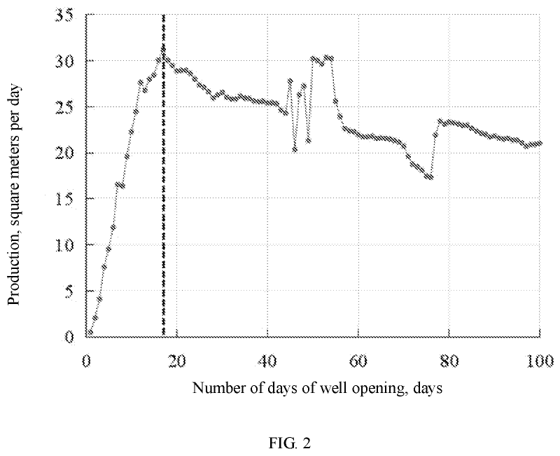

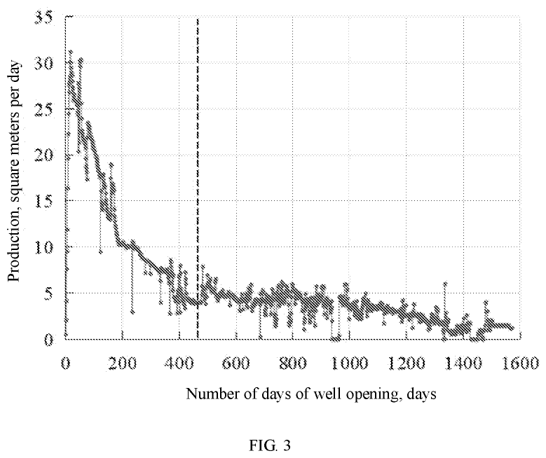

The target well is currently open for 1572 days and reached its maximum production on the 17th day, wherein the life cycle stages are divided according to the method proposed in the present invention, with 0 to the 17th day for the extraction and testing stage, the 18th to the 571th day for the rapid production decline stage, and the 572nd day later for the low pressure and small volume production stage, as shown in FIGS. 2 and 3, with the dashed line in FIG. 2 being the dividing line between the extraction and testing stage and the rapid production decline stage, and the dashed line in FIG. 3 being the dividing line between the rapid production decline stage and the low pressure and small volume production stage.

When the target well is in the drilling and fracturing stage, an EUR evaluation was conducted as follows: the correlation between reservoir physical parameters, engineering construction parameters, and EUR values of 38 reference wells was analyzed, and the results showed that except for pump stop pressure, the correlation between other reservoir physical parameters, engineering construction parameters, and EUR values exceeded 0.7; Further dimensionality reduction was carried out on the selected 19 potential influencing factors, resulting in the final dimensionality reduction of data matrix X_{(8×39)}. Only 8 data in this matrix can retain 92.8% of the original 19 data, achieving a significant reduction in the dimensionality of the analysis data;

Build a multi factor productivity evaluation model for the block where the target well is located, and solve it to obtain its expression as follows:

$$EUR ( d ) = 0.0313 {x}_{1 , d} - 0.03 {x}_{2 , d} - 0.0006 {x}_{3 , d} - 0.0016 {x}_{4 , d} - 0.0743 {x}_{5 , d} - 0.0041 {x}_{6 , d} - 0.054 {x}_{7 , d} + 0.0033 {x}_{8 , d} + 1.4147$$

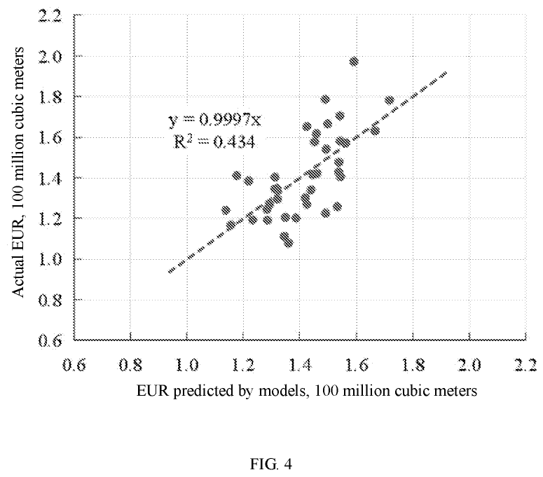

In the above equation, x_{1,d}, x_{2,d}, . . . , x_{8,d} are the first to eighth row elements in column d of data matrix X_{(8×39)}; Bring the data from column 39 of data matrix X_{(8×39)} into the obtained model, and obtain an EUR of 147 million cubic meters for the target well. The comparison between the predicted EUR and the actual EUR of the remaining 38 wells is shown in FIG. 4, and the linear correlation coefficient obtained through fitting is 0.434.

When the target well is in the extraction and testing stage, the EUR evaluation was carried out as follows: using the data matrix X_{(8×39)} obtained after the final dimensionality reduction in the previous section, a regression model for testing production in the block where the target well is located was built by combining the well opening test production and the extraction and testing stage flowback rate. The expression obtained is as follows:

$$EUR ( d ) = 0.004 {x}_{1 , d} - 0.0291 {x}_{2 , d} - 0.0449 {x}_{3 , d} + 0.0085 {x}_{4 , d} - 0.0349 {x}_{5 , d} + 0.0029 {x}_{6 , d} - 0.0268 {x}_{7 , d} + 0.0195 {x}_{8 , d} 0.0214 \times {Q}_{test} ( d ) + 0.0002 \times {R}_{back} ( d ) + 0.913$$

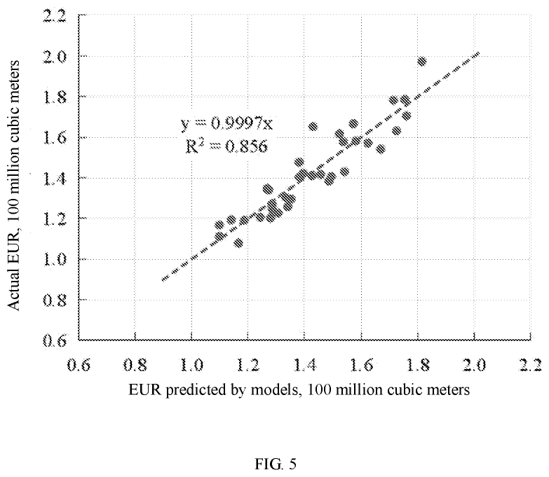

In the above equation, x_{1,d}, x_{2,d}, . . . , x_{8,d} are the first to eighth row elements in column d of data matrix X_{(8×39)}; Qₜₑₛₜ(d) represents the production of the d-th well during the well opening test, in m³; R_{back}(d) represents the flowback rate during the extraction and testing stage of the d-th well; By incorporating the data from column 39 of data matrix X the production of the target well during the well opening test, and the flowback rate during the extraction and testing stage into the obtained model, the EUR of the target well is obtained to be 147 million cubic meters. The comparison between the predicted EUR and the actual EUR of the remaining 38 wells is shown in FIG. 5, and the linear correlation coefficient obtained through fitting is 0.856. It can be seen that the accuracy of the built model is improved with the addition of the extraction and testing data.

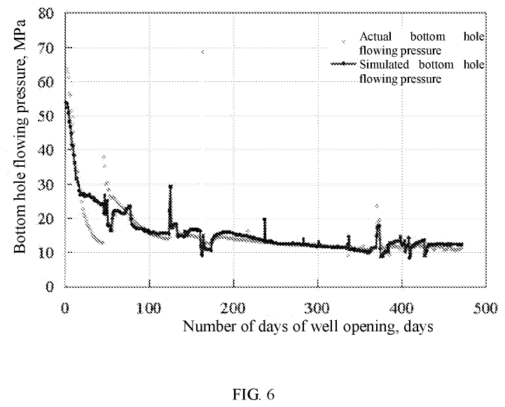

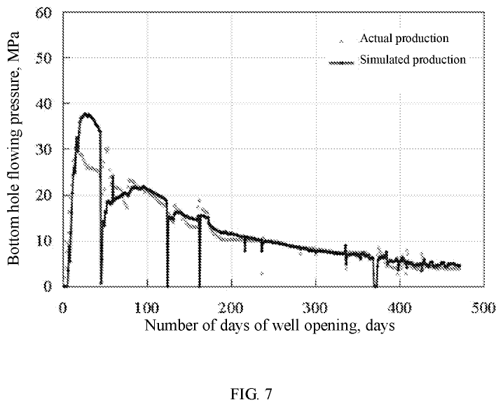

The decline rate calculations were carried out on the 140th, 250th, 360th, 470th, and 580th days of well opening, wherein the decline rates obtained from the previous four calculations were all greater than 0.002d⁻¹, and the decline rate calculated on the 580th day was less than 0.002d⁻¹. It was found that on the 473rd day of well opening, it was the cut-off time point for the rapid production decline stage. The data of the 140th, 250th, 360th, 470th, and 580th days of well opening was solved by Harmony commercial software, and the EUR was 195 million m³, 145 million m³, 147 million m³ and 144 million m³ respectively. FIGS. 6 and 7 illustrate the fitted data at the 470th day of well opening.

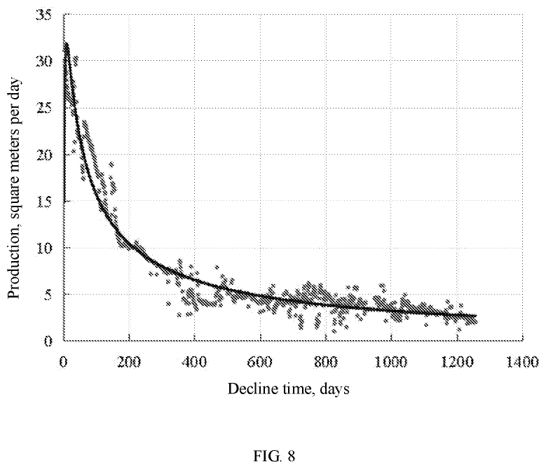

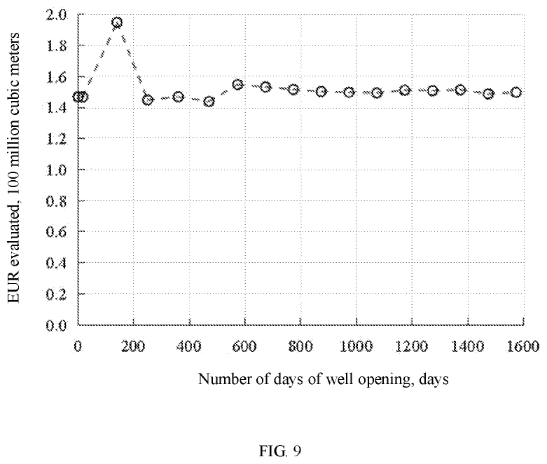

For the data from the low pressure and small volume production stage after the 473rd day, EUR evaluation was carried out at 100-day intervals. Table 2 illustrates the ranking results of decline models under different well opening days, wherein the preferred results for all days are for the Duong decline model, and FIG. 8 illustrates the Duong model fitted production versus actual production on the 1273rd day of well opening. The abandonment condition in this embodiment is 20 years of well operation and production. FIG. 9 shows the tracking and evaluation of the EUR using the method of the present invention at different times in the target well, and it can be seen that the EUR obtained from the evaluation tends to stabilize as the time of well opening increases. At the 140th day, the evaluated EUR was 195 million cubic meters, which is significantly larger than the rest of the time and may have caused misjudgment of the gas wells, indicating that we need to conduct tracking evaluations when evaluating EUR to get a more scientific and comprehensive picture of the oil and gas wells.

TABLE 2
Model preferences and EUR evaluation results at different times
during the low pressure and small volume production stage

| Number of | | EUR, 100 |
|---|---|---|
| days of well | | million cubic |
| opening | Model error ranking | meters |
| 573 | Duong < M-L < Li < Arps < PLE < SEDM | 1.55 |
| 673 | Duong < M-L < Arps < Li < PLE < SEDM | 1.53 |
| 773 | Duong < Li < Arps < M-L < PLE < SEDM | 1.52 |
| 873 | Duong < Li < Arps < M-L < PLE < SEDM | 1.50 |
| 973 | Duong < Li < Arps < PLE < M-L < SEDM | 1.50 |
| 1073 | Duong < PLE < Li < Arps < SEDM < M-L | 1.50 |
| 1173 | Duong < Arps < SEDM < PLE < M-L < Li | 1.51 |
| 1273 | Duong < PLE < Arps < Li < SEDM < M-L | 1.51 |
| 1373 | Duong < Arps < SEDM < PLE < M-L < Li | 1.52 |
| 1473 | Duong < Arps < PLE < Li < SEDM < M-L | 1.49 |
| 1573 | Duong < Arps < PLE < SEDM < Li < M-L | 1.50 |

Note: The EUR values in the above table were fitted by the Duong model.

The life cycle EUR tracking and evaluation method for horizontal wells provided by the present invention, in combination with the production performance data, divides the life cycle stages of fractured horizontal wells in unconventional oil and gas reservoirs, provides corresponding EUR evaluation steps for different life cycle stages based on the production performance characteristics of fractured horizontal wells in unconventional oil and gas reservoirs in the drilling and fracturing stage, extraction and testing stage, rapid production decline stage, and low pressure and small volume production stage, and establishes the EUR tracking and evaluation process of fractured horizontal wells in unconventional oil and gas reservoirs throughout their life cycle from drilling to abandonment, meanwhile, the cyclic tracking and evaluation can continuously improve the accuracy of EUR evaluation for the whole oil extraction block, avoiding the impact of blind use of EUR evaluation methods and one-time evaluation of EUR on oil and gas field development programs. The method of the present invention is easy to operate and can be used to enable orderly EUR tracking and evaluation of fractured horizontal wells in unconventional oil and gas reservoirs throughout their life cycle, which is conducive to the rational and efficient development of unconventional oil and gas resources.

### Embodiment 2

A device that comprises
A processor, and
An acquisition module, which is used to obtain the reservoir physical parameters and engineering construction parameters of the target well, as well as the reservoir physical parameters, engineering construction parameters, and EUR values of the reference wells,
A storage module, on which a program for the life cycle EUR tracking and evaluation of horizontal wells that can be run on the processor is stored, wherein the program for the life cycle EUR tracking and evaluation of horizontal wells is executed by the processor to implement the steps of the method described in Embodiment 1.

An output module, which is used to output the calculation results.

### Embodiment 3

A computer-readable storage medium containing executable program code of a processor, comprising multiple instructions configured to enable the processor to execute the method shown in Embodiment 1.

The above is only a preferred embodiment of the present invention and does not limit it in any form. Although the present invention has been disclosed in preferred embodiments, it is not intended to limit the present invention, and any technical personnel familiar with the profession, within the scope of the technical solution of the present invention, can make some changes or modifications to equivalent embodiments using the disclosed technical content, but any simple modifications, equivalent changes, and modifications made to the above embodiments based on the technical essence of the present invention, without departing from the technical solution of the present invention, shall still fall within the scope of the technical solution of the present invention.

1. A method for tracking and evaluating an estimated ultimate recovery (EUR) of a life cycle of a horizontal well comprising:
S1: obtaining reservoir physical parameters and engineering construction parameters of a target well, using the remaining wells in a block where the target well is located that have been opened for more than 300 days as reference wells, and obtaining reservoir physical parameters, engineering construction parameters, and EUR values of the reference wells;
S2: dividing a life cycle of the target well:
if the target well is not provided with production data, it is judged to be in a drilling and fracturing stage;
if the target well has been opened for less than or equal to 15 days, or if production of the target well continues to increase after an opening, it is judged to be in an extraction and testing stage;
if the production of the target well increases and then decreases, and a time interval between a current production and a maximum production is not more than 30 days, it is judged to be in a rapid production decline stage;
if the production of the target well increases and then decreases, and the time interval between the current production and the maximum production is greater than 30 days, an Arps decline model is used to fit production data from a time of the maximum production to a current time and calculate a decline rate of production at the current time, and if the decline rate of production at the current time is greater than 0.002d⁻¹, it is judged to be in the rapid production decline stage; if the decline rate of production at the current time is less than 0.002d⁻¹, it is judged to be in a low pressure and small volume production stage;
S3: conducting the EUR evaluation based on the stage of the life cycle of the target well, wherein different methods are used to evaluate the EUR of the target well for different stages;
S4: repeating S1-S3 at an intervals until the target well is abandoned, wherein the interval is not less than 15 days; and
when the target well is opened for more than 300 days, the target well is used as a reference well for the remaining wells in the block where the target well is located.

2. The method of claim 1, wherein in S1, the reservoir physical parameters include porosity, permeability, oil saturation, gas saturation, water saturation, and effective reservoir thickness; Engineering construction parameters include wellbore trajectory data, oil casing data, maximum true vertical depth, horizontal section length, fracturing length, number of fracturing sections, average section spacing, total sand addition, total liquid consumption, sanding strength, liquid consumption strength, single stage sand addition, single stage liquid production, peak pump pressure, pump stop pressure, and peak pump displacement; When the target well is a shale gas well, the reservoir physical parameters also include organic matter content, gas content, and brittle mineral content.

3. The method of claim 1, wherein in S2, the production is determined by converting the gas production to the corresponding oil production and superimposing it on the production when a gas production situation exists for oil wells, and converting the oil production to the corresponding gas production and superimposing it on the production when a condensate production situation exists for gas wells.

4. The method of claim 1, wherein in S3, when the life cycle of the target well is in the drilling and fracturing stage, the following steps are used to evaluate its EUR value:
S301. Record reservoir physical parameters and engineering construction parameters as evaluation factors; For the reference well, compose the evaluation factor data into a matrix
$${H}_{( s \times k )} = [ \begin{matrix}{h}_{1 , 1} & {h}_{1 , 2} & … & {h}_{1 , k} \\ {h}_{2 , 1} & {h}_{2 , 2} & … & {h}_{2 , k} \\ ⋮ & ⋮ & {h}_{i , j} & ⋮ \\ {h}_{s , 1} & {h}_{s , 2} & … & {h}_{s , k}\end{matrix} ] ,$$
and compose its EUR data into a matrix E_{(l×k)}=[e_{1,1} e_{1,2} . . . e_{l,j} . . . e_{l,k}], where s represents the number of selected evaluation factors and k represents the number of reference wells; Meanwhile, h_{i,j} represents the i-th evaluation factor value of the j-th well, and e_{l,j} represents the EUR value of the j-th well; j=1, 2, . . . ,k, i=1, 2, . . . ,s;
S302. Normalize matrix H_{(s×k)} to obtain matrix
$${\overline{H}}_{( s \times k )} = [ \begin{matrix}{\overline{h}}_{1 , 1} & {\overline{h}}_{1 , 2} & … & {\overline{h}}_{1 , k} \\ {\overline{h}}_{2 , 1} & {\overline{h}}_{2 , 2} & … & {\overline{h}}_{2 , k} \\ ⋮ & ⋮ & {\overline{h}}_{i , j} & ⋮ \\ {\overline{h}}_{s , 1} & {\overline{h}}_{s , 2} & … & {\overline{h}}_{s , k}\end{matrix} ] ,$$
and normalize matrix E_{(l×k)} to obtain matrix Ē_{(l×k)}=[ē_{1,1} ē_{1,2} . . . ē_{1,j} . . . ē_{1,k}], where, h̅_{i,j}=h_{i,j}/h_{1,l}, ē_{1,f}=e_{1,f}/e_{1,1}; Simultaneously establish matrix
$${G}_{( s \times k )} = [ \begin{matrix}{g}_{1 , 1} & {g}_{1 , 2} & … & {g}_{1 , k} \\ {g}_{2 , 1} & {g}_{2 , 2} & … & {g}_{2 , k} \\ ⋮ & ⋮ & {g}_{i , j} & ⋮ \\ {g}_{s , 1} & {g}_{s , 2} & … & {g}_{s , k}\end{matrix} ] ,$$
where g_{i,j}=h̅_{i,j}−ē_{1,j};
S303. Establish matrix
$${F}_{( s \times k )} = [ \begin{matrix}{f}_{1 , 1} & {f}_{1 , 2} & … & {f}_{1 , k} \\ {f}_{2 , 1} & {f}_{2 , 2} & … & {f}_{2 , k} \\ ⋮ & ⋮ & {f}_{i , j} & ⋮ \\ {f}_{s , 1} & {f}_{s , 2} & … & {f}_{s , k}\end{matrix} ] , where$$
$${f}_{i , j} = \frac{min ( \vert {G}_{( s \times k )} \vert ) + 0.5 \times max ( \vert {G}_{( s \times k )} \vert )}{\vert {g}_{i , j} \vert + 0.5 \times max ( \vert {G}_{( s \times k )} \vert )} ,$$
min(|G_{(s×k)}|) represent the absolute values corresponding to the element with the smallest absolute value in matrix G_{(s×k)}, max(|G_{(s×k)}|) represents the absolute value corresponding to the element with the largest absolute value in matrix G_{(x×k)}, and |g_{i,f}| represents the absolute value of element g_{i,f} in matrix G_{(s×k)};
S304. Obtain the correlation matrix U_{(x×l)}=[u_{1,1} u_{2,3} . . . u_{i,1} . . . u_{i,1}]^{T} between each evaluation factor and the EUR value, where
$${u}_{i , 1} = \frac{1}{k} {\sum }_{j = 1}^{k} {f}_{i , j}$$
represents the correlation between the i-th evaluation factor and the EUR value;
S305. Select reservoir physical parameters and engineering construction parameters with a correlation degree greater than 0.7 in S315 as potential influencing factors; Compose the potential influencing factor data of the target well and the reference well into a matrix
$${Q}_{( m \times ( k + 1 ) )} = [ \begin{matrix}{q}_{1 , 1} & {q}_{1 , 2} & … & {q}_{1 , k + 1} \\ {q}_{2 , 1} & {q}_{2 , 2} & … & {q}_{2 , k + 1} \\ ⋮ & ⋮ & {q}_{y , d} & ⋮ \\ {q}_{m , 1} & {q}_{m , 2} & … & {q}_{m , k + 1}\end{matrix} ] ,$$
where m represents the number of potential influencing factors, k represents the number of reference wells, q_{y,d} represents the y-th potential influencing factor value of the d-th well, and d=1, 2, . . . , k, k+1, y=1, 2, . . . , m; The first k columns of matrix Q_{(m×(k+1))} are the potential influencing factor data of the reference well, and the k+1st column is the potential influencing factor data of the target well;
S306. Standardize matrix Q_{(m×(k+1))} to obtain standardized matrix Q′_{(m×(k+1))}, obtain the covariance moment C_{(m×m)} of matrix Q′_{(m×k+1))}, and then obtain the standard orthogonal feature matrix Z_{(m×m)} of matrix C_{(m×m)}; Then, transpose matrix Z_{(m×m)} to obtain matrix \hat{Z}_{(m×m)}; Multiply matrix \hat{Z}_{(m×m)} by matrix Q′_{(m×(k+1))} to obtain matrix P_{(m×(k+1))};
Calculate the variance FC_{y} of each row in matrix P_{(m×(k+1))}, y=1, 2, . . . , m, and calculate the variance and FCH, where, FCH=FC₁+FC₂+ . . . +FCₘ; Arrange the elements of matrix P_{(m×(k+1))} in descending order according to the variance size of each row; GX_{y}=FC_{y}/FCH, GX_{y} is the contribution rate of the y-th row of data in matrix P_{(m×(k-1))} to the original data information; At this time, retain the first w rows of data in matrix P_{(m×(k+1))} that have a cumulative contribution rate of more than 90% to the original data information, and obtain matrix X_{(m×(k+1))};
S307. Build a EUR evaluation multi-factor productivity model for the block where the target well is located, with the specific expression as follows:
$$EUR ( d ) = {\sum }_{t = 1}^{w} {a}_{t} {x}_{t , d} + ε$$
Where, t=1, 2, . . . , w; w is the number of rows in matrix X_{(m×(k+1))}; d=1, 2, . . . , k, k+1; k represents the number of reference wells, EUR(d) is the predicted EUR value of the d-th well, in m³; αₜ and ε are the multi-factor productivity model parameters for the EUR evaluation of the target well in the block, which are constants x_{l,d} is the data in the t-th row and d-th column of matrix X_{(m×(k+1))};
S308. Based on the data in the first k columns of matrix X_{(m×(k+1))} and the EUR value of the reference well, the multi-factor productivity model for EUR evaluation is solved, and the final parameters brought into the target well are the data in the k+1st column of matrix X_{(m×(k+1))}, to obtain the EUR value of the target well.

5. The method of claim 1, wherein in S3, when the life cycle of the target well is in the extraction and testing stage, the following steps are used to evaluate its EUR value:
S311. Repeat S2 every other day until the end of the extraction and testing stage, and calculate the flowback rate and opening test production of the target well during the extraction and testing stage;
S312. Record reservoir physical parameters and engineering construction parameters as evaluation factors; For the reference well, compose the evaluation factor data into a matrix
$${H}_{( s \times k )} = [ \begin{matrix}{h}_{1 , 1} & {h}_{1 , 2} & … & {h}_{1 , k} \\ {h}_{2 , 1} & {h}_{2 , 2} & … & {h}_{2 , k} \\ ⋮ & ⋮ & {h}_{i , j} & ⋮ \\ {h}_{s , 1} & {h}_{s , 2} & … & {h}_{s , k}\end{matrix} ] ,$$
and compose its EUR data into a matrix E_{(l×k)}=[e_{1,1} e_{1,2} . . . e_{1,j} . . . e_{1,k}]; where s represents the number of selected evaluation factors and k represents the number of reference wells; Meanwhile, h_{i,j} represents the i-th evaluation factor value of the j-th well, and e_{1,j} represents the EUR value of the j-th well; j=1, 2, . . . , k, i=1,2, . . . ,s;
S313. Normalize matrix H_{(s×k)} to obtain matrix
$${\overline{H}}_{( s \times k )} = [ \begin{matrix}{\overline{h}}_{1 , 1} & {\overline{h}}_{1 , 2} & … & {\overline{h}}_{1 , k} \\ {\overline{h}}_{2 , 1} & {\overline{h}}_{2 , 2} & … & {\overline{h}}_{2 , k} \\ ⋮ & ⋮ & {\overline{h}}_{i , j} & ⋮ \\ {\overline{h}}_{s , 1} & {\overline{h}}_{s , 2} & … & {\overline{h}}_{s , k}\end{matrix} ] ,$$
and normalize matrix E_{(l×k)} to obtain matrix Ē(l×k)=[ē_{1,1} ē_{1,2} . . . ē_{1,j} . . . ē_{1,k}], where, h̅_{i,j}=h_{i,j}/h_{i,l}, ē_{1,f}=e_{1,f}/e_{1,1}; Simultaneously establish matrix
$${G}_{( s \times k )} = [ \begin{matrix}{g}_{1 , 1} & {g}_{1 , 2} & … & {g}_{1 , k} \\ {g}_{2 , 1} & {g}_{2 , 2} & … & {g}_{2 , k} \\ ⋮ & ⋮ & {g}_{i , j} & ⋮ \\ {g}_{s , 1} & {g}_{s , 2} & … & {g}_{s , k}\end{matrix} ] ,$$
where g_{i,j}=h̅_{i,j}−ē_{1,j};
S314. Establish matrix
$${F}_{( s \times k )} = [ \begin{matrix}{f}_{1 , 1} & {f}_{1 , 2} & … & {f}_{1 , k} \\ {f}_{2 , 1} & {f}_{2 , 2} & … & {f}_{2 , k} \\ ⋮ & ⋮ & {f}_{i , j} & ⋮ \\ {f}_{s , 1} & {f}_{s , 2} & … & {f}_{s , k}\end{matrix} ] , where$$
$${f}_{i , j} = \frac{min ( \vert {G}_{( s \times k )} \vert ) + 0.5 \times max ( \vert {G}_{( s \times k )} \vert )}{\vert {g}_{i , j} \vert + 0.5 \times max ( \vert {G}_{( s \times k )} \vert )} ,$$
min (|G_{(s×k)}|) represent the absolute values corresponding to the element with the smallest absolute value in matrix G_{(s×k)}, max(|G_{(s×k)}|) represents the absolute value corresponding to the element with the largest absolute value in matrix G_{(s×k)}, and |g_{i,j}| represents the absolute value of element g_{i,j} in matrix G_{(s×k)};
S315. Obtain the correlation matrix U_{(x×l)}=[u_{1,1} u_{2,1} . . . u_{i,1} . . . u_{s,1}]^{T} between each evaluation factor and the EUR value, where
$${u}_{i , 1} = \frac{1}{k} {\sum }_{j = 1}^{k} {f}_{i , j}$$
represents the correlation between the i-th evaluation factor and the EUR value;
S316. Select reservoir physical parameters and engineering construction parameters with a correlation degree greater than 0.7 in S315 as potential influencing factors; Compose the potential influencing factor data of the target well and the reference well into a matrix
$${Q}_{( m \times ( k + 1 ) )} = [ \begin{matrix}{q}_{1 , 1} & {q}_{1 , 2} & … & {q}_{1 , k + 1} \\ {q}_{2 , 1} & {q}_{2 , 2} & … & {q}_{2 , k + 1} \\ ⋮ & ⋮ & {q}_{y , d} & ⋮ \\ {q}_{m , 1} & {q}_{m , 2} & … & {q}_{m , k + 1}\end{matrix} ] ,$$
where m represents the number of potential influencing factors, k represents the number of reference wells, q_{y,d} represents the y-th potential influencing factor value of the d-th well, and d=1, 2, . . . , k, k+1, y=1, 2, . . . , m; The first k columns of matrix Q_{(m×(k+1))} are the potential influencing factor data of the reference well, and the k+1st column is the potential influencing factor data of the target well;
S317. Standardize matrix Q_{(m×(k+1))}, to obtain standardized matrix Q′_{(m×(k+1))}, obtain the covariance moment C_{(m×m)} of matrix Q′_{(m×(k+1))}, and then obtain the standard orthogonal feature matrix Z_{(m×m)} of matrix C_{(m×m)}; Then, transpose matrix Z_{(m×m)} to obtain matrix \hat{Z}_{(m×m)}; Multiply matrix \hat{Z}_{(m×m)} by matrix Q′_{(m×(k+1))} to obtain matrix P_{(m×(k+1))};
Calculate the variance FC_{y} of each row in matrix P_{(m×(k+1))}, y=1, 2, . . . , m, and calculate the variance and FCH, where, FCH=FC₁+FC₂+ . . . +FCₘ; Arrange the elements of matrix P_{(m×(k+1))} in descending order according to the variance size of each row; GX_{y}=FC_{y}/FCH, GX_{y} is the contribution rate of the y-th row of data in matrix P_{(m×(k+1))} to the original data information; At this time, retain the first w rows of data in matrix P_{(m×(k+1))} that have a cumulative contribution rate of more than 90% to the original data information, and obtain matrix X_{(m×(k+1))};
S318. Build a regression model for EUR evaluation of testing production in the block where the target well is located, with the specific expression as follows:
$$EUR ( d ) = {\sum }_{t = 1}^{w} {b}_{t} {x}_{t , d} + α {Q}_{test} ( d ) + β {R}_{back} ( d ) + φ$$
Where, t=1, 2, . . . , w; w is the number of rows in matrix X_{(m×(k+1))}; d=1, 2, . . . , k, k+1, k represents the number of reference wells, EUR(d) is the predicted EUR value of the d-th well, in m³; bₜ, α, β and φ are the multi-factor productivity model parameters for the EUR evaluation of the target well in the block, which are constants X_{t,d} is the data in the t-th row and d-th column of matrix X_{(m×(k+1))}, Qₜₑₛₜ(d) represents the production of the d-th well during the well opening test, in m³, R_{back}(d) represents the flowback rate during the extraction and testing stage of the d-th well;
S319. Based on the data in the first k columns of matrix X_{(m×(k+1))}, as well as the EUR value of the reference well, the production data during the well opening test, and the flowback rate data during the extraction and testing stage, the EUR evaluation regression model for testing production is solved; The parameters of the target well, namely the data in the k+1st column of matrix X_{(m×(k+1))}, as well as the production data during the well opening test and the flowback rate data during the extraction and testing stage, can be used to obtain the EUR value of the target well.

6. The method of claim 1, wherein in S3, when the life cycle of the target well is in the rapid production decline stage, the conventional commercial software is used to evaluate its EUR, and the conventional commercial software includes Harmony.

7. The method of claim 1, wherein in S3, when the life cycle of the target well is in the low pressure and small volume production stage, the following steps are used to evaluate its EUR value:
S331. Use the pauta criterion to judge the data after maximum production and identify abnormal data points; And use the Exponential Moving Average to fill in the marked abnormal data points;
S332. Divide the production data of the filled low pressure and small volume production stage into two sections, record the first half of the data and the production data from the maximum production to the low pressure and small volume production stage as the fitting dataset, and record the production data of the low pressure and small volume production stage as the validation dataset;
S333. Use Duong decline model, SEDM decline model, PLE decline model, Arps decline model, Li decline model, and M-L decline model to fit the fitted dataset, and select the optimal decline model based on the error between the calculated production and actual production in the validation dataset;
S334. Based on the optimal decline model selected in S333, the data of the target well is brought in, and the final EUR value of the target well is calculated.

8. (canceled)

9. A device, comprising a processor and an acquisition module which is used to obtain reservoir physical parameters and engineering construction parameters of a target well, as well as reservoir physical parameters, engineering construction parameters, and EUR values of reference wells,
A storage module, on which a program that can be run on the processor is stored, wherein the program is executed by the processor to implement the steps of the method of claim 1, and an output module, which is used to output calculation results.

10. A computer-readable storage medium containing executable program code of a processor, characterized in that the computer-readable storage medium stores multiple instructions configured to enable the processor to execute the method of claim 1.
